(19) United States
(12) Patent Application Publication
(10) Pub. No.: US 2010/0077036 A1
(43) Pub. Date: Mar. 25, 2010

(54) SYSTEM AND METHOD FOR INTERACTIVELY OBTAINING ACCESS TO RESTRICTED CONTENT

(76) Inventors: Lisa Seacat DeLuca, San Francisco, CA (US); Lydia M. Do, Research Triangle Park, NC (US); Steven M. Miller, Cary, NC (US)

Correspondence Address: IBM CORPORATION, 3039 CORNWALLIS RD., DEPT. T81 / B503, PO BOX 12195, RESEARCH TRIANGLE PARK, NC, 27709, US

(21) Appl. No.: 12/237,989

(22) Filed: Sep. 25, 2008

(51) Int. Cl. G06F 15/16

(52) U.S. Cl. 709/206

(57) ABSTRACT

The present invention is directed to a system, method and program product for interactively obtaining access to restricted content. A system is disclosed that includes a first device operable by a restricted party to transmit an access request to a restricting party. The access request requests access to the restricted content or to restricted event. A server receives the access request and relays it to the restricting party. A second device that is operable by the restricting party receives the access request from the server and transmits an access request response to the first device via the server.

### FIELD OF THE INVENTION

The present invention relates to obtaining access to restricted content. More specifically, the present invention relates to a system, method and program product for obtaining a restricted party's access to content by interaction between the restricted party and the restricting party.

### BACKGROUND OF THE INVENTION

A user's access to certain content may be restricted for various reasons. For example, a parent may restrict a child's access to certain TV channels or certain websites on the Internet in order to protect the child from inappropriate material. Another example involves restriction of employee access to certain software, such as chat programs or Internet browsers, so as to avoid employee distraction from work.

Various software programs are available to accomplish access restriction to certain content. For example, the software program “Parent Tools” is a powerful yet easy-to-use tool for monitoring and controlling access to AOL Instant Messenger (AIM). “Parent Tools” allows AIM conversations to be silently saved; AIM features to be blocked; and online time to be limited, for example.

As another example, the software program “ChatBlocker” is a powerful desktop parental control application for moderating and restricting chat conversations. Time slots can be easily set up in which chat conversations may be allowed or disallowed. Furthermore, advanced security and low level blocking features and functionality prevent “ChatBlocker” from being tampered with by users of the PC.

Further examples include “ComputerTime” and “iNet Protector”. “ComputerTime” is a parental control program that enables parents to set limits on the amount of time and the time of day when their children can use the computer. “iNet Protector” allows for Internet access restrictions or for password-protection of Internet connections at specified times or on demand. An Internet connection can be disabled completely or Internet access can be restricted to work with allowed programs or services only.

The available software programs and methods for access restriction to certain content are limited in that the access restrictions are initially set by an enforcer/restricting party with little or no input from the restricted party. An approach that is more interactive between the enforcer/restricting party and the restricted party is needed.

### SUMMARY OF THE INVENTION

A first aspect of the present invention is directed to a system for interactively obtaining access to at least one of restricted content and a restricted event, the system comprising: a first device operable by a restricted party to transmit an access request to a restricting party, the access request requesting access to the at least one of the restricted content and the restricted event; a server operable to receive the access request and to relay the access request to the restricting party; and a second device operable by the restricting party to receive the access request from the server and to transmit an access request response to the first device via the server.

A second aspect of the present invention is directed to a method for interactively obtaining access to at least one of restricted content and a restricted event, the method comprising: transmitting an access request from a first device of a restricted party to a second device of a restricting party, the access request requesting access to the at least one of the restricted content and the restricted event; receiving the access request at a server; relaying the access request from the server to the second device of the restricting party; receiving the access request at the second device of the restricting party; and transmitting an access request response from the second device to the first device via the server.

A third aspect of the present invention is directed to a program product stored on a computer readable medium for interactively obtaining access to at least one of restricted content and a restricted event, the program product comprising: program code for receiving an access request from a first device of a restricted party to a second device of a restricting party, the access request requesting access to the at least one of the restricted content and the restricted event; program code for relaying the access request to the second device of the restricting party; and program code for receiving an access request response from the second device to the first device.

A fourth aspect of the present invention is directed to a method for deploying an application for interactively obtaining access to at least one of restricted content and a restricted event, comprising: providing an infrastructure being operable to: receive an access request from a first device of a restricted party to a second device of a restricting party, the access request requesting access to the at least one of the restricted content and the restricted event; relay the access request to the second device of the restricting party; and receive an access request response from the second device to the first device.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts a system in accordance with an illustrative embodiment of the present invention;

FIG. 2 depicts a system in accordance with another illustrative embodiment of the present invention;

FIG. 3 depicts a system in accordance with yet another illustrative embodiment of the present invention;

FIG. 4 depicts a system in accordance with still another illustrative embodiment of the present invention; and

FIG. 5 depicts a flowchart of a method in accordance with an illustrative embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

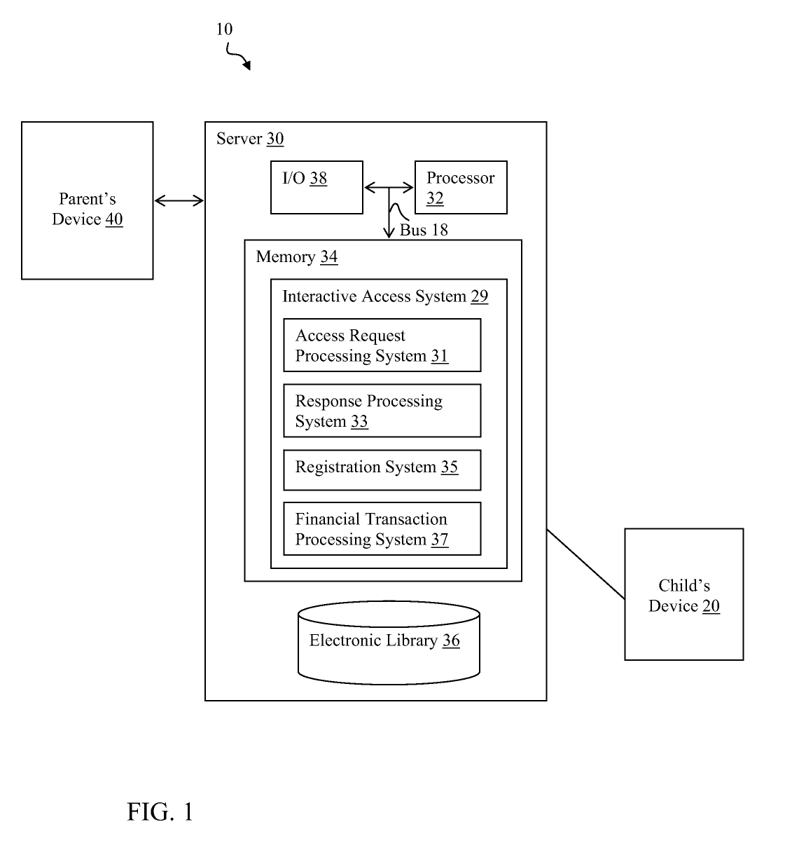

FIG. 1 shows an illustrative embodiment of a system 10 according to the present invention. The illustrative system 10 includes a child's device 20; a server 30; and a parent's device 40.

The devices 20 and 40 may include any electronic device capable of receiving and sending signals, such as Personal Digital Assistants (PDAs), cellular phones, handheld computers, PCs, laptops, etc. The server 30 may include a processor 32, memory 34, and an electronic library 36. Stored in memory is an interactive access system 29.

If the child visits a movie theater to watch a movie that requires parental authorization, for example because the movie has a rating that requires parental consent, the child may use the device 20 to transmit an authorization request to the parent's device 40 via the interactive access system on server 30. The authorization request may be, for example, a Short Message Service (SMS) or email message asking “Can I see movie X?”. However, the authorization request may include any other language or be any other communication that communicates to the parent the child's desire to watch movie X. For example, the authorization request may include arguments or reasons why access to a particular movie is necessary, desirable or beneficial to the child.

The server 30 includes an access request processing system 31 that receives the child's authorization request and relays it to the parent's device 40, which then displays the authorization request to the parent. The parent may then transmit an authorization request response, again in the form of an SMS or email message, for example, back to the child's device 20 via the server 30, which is handled by response processing system 33. The authorization request response may be a simple “Yes”, thereby granting authorization to the child to watch movie X, or a simple “No”, thereby denying authorization to the child to watch the movie. However, rather than a simple “Yes” or “No”, the authorization request response may include any other language or be any other communication that communicates to the child authorization or denial of authorization to watch the movie. After receipt at the child's device 20, the device 20 may display the authorization request response to the child. A registration system 35 may be utilized to register users of the system.

If the parent's authorization request response authorizes the child to watch movie X, then the child may show the authorization request response to the sales clerk at the movie theater. The sales clerk may then issue a ticket for movie X to the child.

Rather than an SMS or email message, the child's authorization request may be a phone call from the child's device 20 to the parent's device 40 via the server 30. In this case, the child verbally asks the parent for authorization to watch the movie. If the parent gives his/her authorization, the child may hand the child's device 20 to the sales clerk at the movie theater in order for the sales clerk to obtain verbal permission from the parent to issue the child a movie ticket.

It is not necessary for the authorization request and the authorization request response to be in the same form. For example, the child's authorization request maybe in the form of an SMS message, but the parent's authorization request response may be in the form of an email message, telephone call, facsimile, voice response, or any other form of communication. Any combination of these communication forms for the authorization request and the authorization request response is within the scope of the present invention.

The system 10 may include more than one parent's device 40. For example, the system 10 may include one parent's device for the father of the child, and one parent's device for the mother of the child. Rather than transmitting an authorization request from the child's device 20 to only one parent's device 40, if the child is required to obtain both parents' authorization to watch the movie, the child may transmit the access request to both the father's device and the mother's device. Both the father's device and the mother's device may then transmit their respective authorization request response back to the child's device 20.

To ensure that the child actually contacts a parent, and not any other person that may not be authorized to give permission to watch the movie, such as a classmate of the child, the child's device may include, for example, a designated key that the child presses to initiate authorization requests. The phone number of the parent's device 40 may be pre-programmed into the child's device 20, so that, when the child presses the designated key, the child's device 20 automatically dials the phone number of the parent's device 40. Thus, only the parent can be the recipient of the authorization request, and not any other person that may not be authorized to respond to the child's authorization request.

Rather than providing a separate, designated key on the device 20 that the child must press to initiate authorization requests, authorization requests may also be initiated by pressing a predetermined combination of the typical alphanumerical keys on the child's device 20. By pressing this combination, the child's device 20 may automatically transmit the child's authorization request to the device 40 of the parent only. Again, the phone number of the parent's device 40 may have been preprogrammed into the child's device 20.

Alternatively, rather than dialing the phone number of the parent's device 40, the child may dial the phone number of the server 30 and transmit the authorization request and a unique identification number (ID) of the child's device 20 to the server 30. The server 30 recognizes the transmission from the child's device 20 as an authorization request and using data in the electronic library 36, the server processor 32 matches the child's device's ID number with the phone number of the parent's device 40. The parent's device 40 may have been previously registered with the server 30, and stored in at least one of the electronic library 36 or memory 34 so that, upon matching the child's device's ID number with the phone number of the parent's device 40, the server 30 relays the authorization request to the parent's device 40 only, and not to any other person or device that may not be authorized to receive authorization requests from the child's device 20. The child's device's unique ID number may simply be the device's phone number, for example.

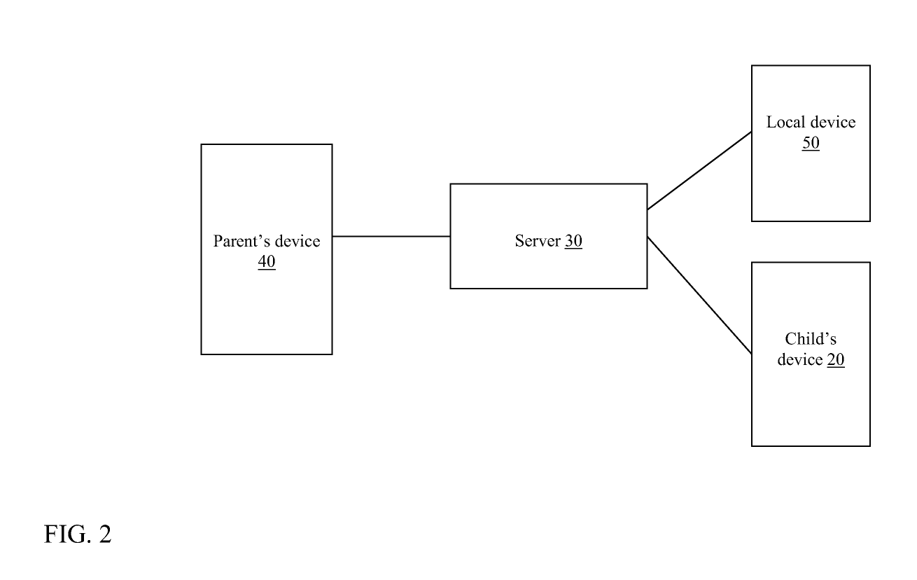

As shown in FIG. 2, the system 10 may also include a local device 50, which is situated, for example, locally in the movie theater that the child is visiting. Instead of or in addition to transmitting the authorization request response from the parent's device 40 to the child's device 20, the parent's device 40 may transmit the authorization request response to the local device 50. The local device 50 may then display the authorization request response from the parent's device 40. The local device 50 may be located in the vicinity of the sales clerk in the movie theater, so that, upon display of the parent's authorization request response, the sales clerk can locally check, independently of the child's device 20, whether the parent authorized or denied the child's access to the movie.

In addition to authorizing the child to watch a particular movie, the parent's authorization request response may also include data authorizing the server 30 to charge a parent's financial account for payment of the movie ticket. This can be handled via financial transaction processing system 37 (FIG. 1). A parent's financial account may include, for example, a bank account, a credit card account or a debit card account. The appropriate account information, such as bank account number, bank routing number, credit card number, etc., may have been previously stored on the server 30, so that the server 30 may automatically and promptly charge the parent's financial account upon receipt of the parent's authorization request response. Instead of the authorization request response itself including the data authorizing the server 30 to charge a parent's financial account, the parent's device 40 may transmit a separate message to the server 30 authorizing the charge. The separate message may, for example, include the appropriate financial account data necessary for the server 30 to successfully charge the parent's financial account.

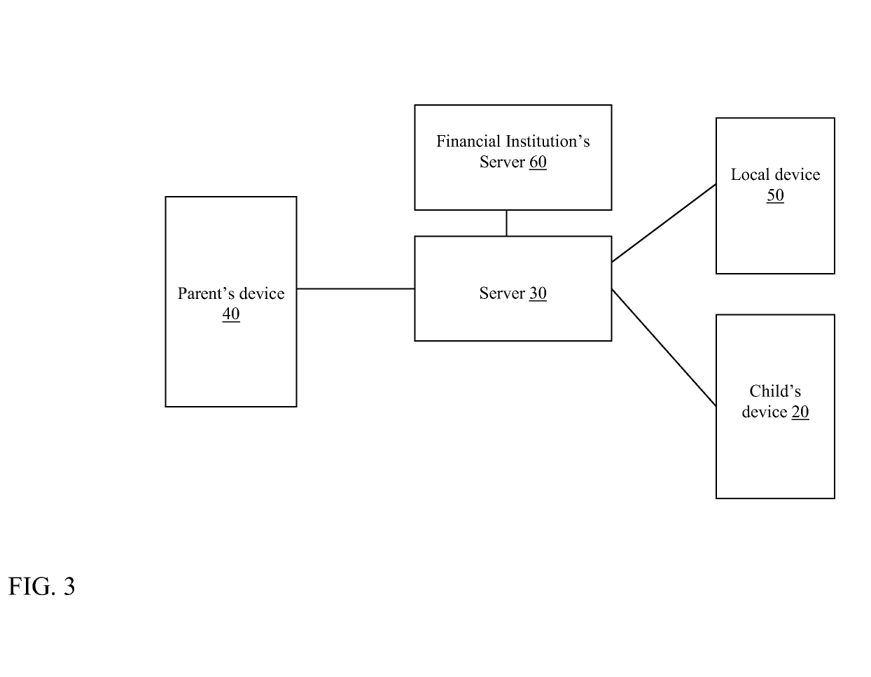

As shown in FIG. 3, after the server 30 received authorization from the parent's device 40 to charge the parent's financial account, the server 30 may communicate with a server 60 of the financial institution associated with the parent's financial account in order to accomplish the charge. After the parent's financial account has been successfully charged, the server 60 may transmit a confirmation message back to the server 30. The server 30 may relay this confirmation message or transmit a separate confirmation message to the parent's device 40 confirming to the parent successful payment for the child's movie ticket. The server 30 may also relay the confirmation message from the server 60 or send a separate, appropriate confirmation message to the child's device 20 and/or the local device 50, so that the sales clerk can now issue the paid for movie ticket to the child.

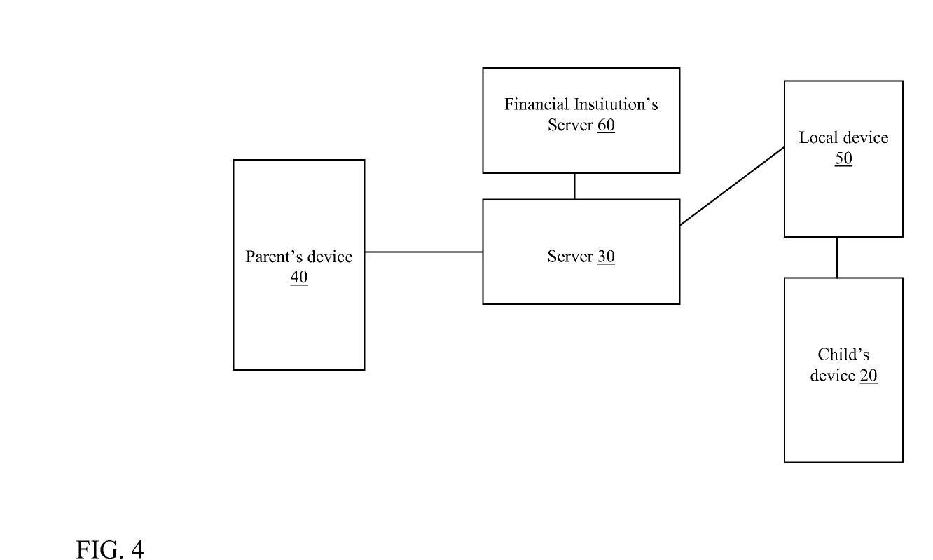

As shown in FIG. 4, rather than the child's device 20 transmitting the authorization request directly to the server 30, the child's device 20 may transmit the authorization request to the server 30 via the local device 50. This may be accomplished through a wireless or a wired connection of the child's device 20 to the local device 50. Alternatively, the child's device 20 may physically and immediately contact the local device 50 and accomplish communication with the local device 50 by means of this immediate physical connection. The local device 50 may then relay the authorization request of the child's device 20 to the server 30, which may then relay the authorization request to the parent's device 40.

Rather than the child's device 20 initiating the authorization request, it may be the local device 50 that initiates the authorization request.

In addition to the authorization request, whether relayed from the child's device 20 or initiated by the local device 50, the local device 50 may also transmit information associated with the location of the movie theater or the location of the local device 50 to the server 30. The server 30 may then relay this location information to the parent's device 40. This information may be, for example, the name, address, telephone number, fax number, and/or the physical coordinates of the movie theater or the local device 50, and may have been preprogrammed into the local device 50. Alternatively, if the physical coordinates of the local device 50 are transmitted to the server 30, the local device 50 may dynamically update its physical coordinates, for example via Global Positioning System (GPS) methods, triangulation methods, or other known location determination methods.

In another illustrative embodiment of the present invention, the local device 50 may transmit a pre-assigned local device identification number to the server 30. The pre-assigned local device identification number may be unique to the local device 50 and its location. Upon receipt of the local device identification number at the server 30, the server 30 may match the local identification number with, for example, the name, address, telephone number, fax number and/or physical coordinates of the movie theater, which may have been previously stored on the server 30. The server 30 may then transmit this information to the parent's device 40.

By displaying this information on the parent's device 40, the parent can confirm that his/her child is actually at the movie theater in question at the moment the child is transmitting the authorization request to watch the movie. Alternatively, rather than the local device 50, the child's device 20 may transmit information associated with its location, such as its physical coordinates, to the parent's device 40. Again, the physical coordinates of the child's device 20 may be determined by GPS, triangulation, or other known location determination methods.

In an illustrative embodiment of the present invention, Interactive Voice Response (IVR) software may be implemented on the server 30 to facilitate the authorization process for access of the child to the movie. If the server 30 receives an authorization request from the child's device 20, the IVR software may prompt the child to furnish certain information either verbally or by pressing the alphanumerical keys on the child's device 20. For example, if the server 30 receives the above-mentioned information associated with the location of the movie theater or of the local device 50, the server 30 may access a database containing all the movies that are being shown at that particular movie theater within a predetermined time window, and then ask the child to select the movie that the child wishes to obtain authorization for. The server 30 may then relay the child's movie selection to the parent's device 40, and the IVR software may ask the parent for an authorization decision on that particular movie. Once the parent transmitted his or her authorization decision to the server 30, the IVR software may relay the authorization decision to the child and/or the sales clerk at the movie theater.

The various communications between the devices 20, 40, 50 and the servers 30 and 60 may be accomplished through wired connections, such as fiber optic connections, or wireless connections, such as WIFI connections, cellular network connections, or wireless computer network connections.

Depending on the particular content that the child desires access to, the child may be required to obtain the authorization to access the content from different people or from a different combination of people. For example, if the child desires to watch a movie in a movie theater, the child may have to obtain authorization from the child's father. However, if the child wishes the rent a movie from a video rental store, the child may be required to obtain authorization from the child's mother, or from both the child's mother and father.

To ensure that the server 30 relays the child's authorization request to the appropriate people, the devices 40 may be registered with the server 30 for a particular combination of the child's device's ID number (such as the device's phone number) and the local device's ID number. For example, if the server 30 receives an authorization request from the child's device 20 via the local device 50 that is located at the movie theater, then the server 30 will match the child's device's unique ID number and the ID number of the local device 50 with that parent's device 40 that was previously registered with the server 30 for this particular combination of child's device's ID number and local device's ID number. In the case of the movie theater, the previously registered device 40 may be that of the father. Thus, the server 30 relays the child's authorization request to the father only.

If, however, the server 30 receives an authorization request from the child's device 20 via the local device 50 that is located at the video rental store, then the server 30 will match the child's device's unique ID number and the local device's ID number with the device 40 or the devices 40 that were previously registered for that particular combination of child's device' ID number and local device's ID number. In the case of the video rental store, the previously registered device 40 or devices 40 may be that of the mother or those of the mother and father. Thus, the server 30 relays the child's authorization request to the mother only, or to the mother and the father, depending on which of the devices 40 was previously registered for this particular situation at the server 30.

Illustrative embodiments of the present invention are not limited to a child transmitting an authorization request to a parent, or to a parent transmitting an authorization request response back to the child. Rather, any restricted party may transmit an authorization request to any corresponding restricting party, and the corresponding restricting party may transmit an authorization request response back to the restricted party. Examples for restricted party-restricting party relationships include not only child-parent relationships, but also employee-supervisor relationships, incapacitated person-guardian relationships, student-teacher relationships, or any other voluntary or even involuntary restricted party-restricting party relationships.

In accordance with another illustrative embodiment of the present invention, the local device 50 may be located at a video distribution center or video rental store. A child or other restricted party may transmit an authorization request to the parent's device 40 or the device 40 of the corresponding restricting party in order to obtain authorization for renting a particular movie, for example, a movie with a rating that expressly requires parental consent before it can be rented to a minor. The sales clerk at the video distribution center or video rental store may then check the local device 50 to determine if authorization has been given, and, if appropriate, if payment for the movie has been made.

In accordance with yet another illustrative embodiment of the present invention, the local device 50 may be located at a pharmacy, and a child or other restricted party may transmit an authorization request to the parent's device 40 or the device 40 of the corresponding restricting party in order to obtain authorization to, for example, pick up, drop off, or sign for pharmaceutical products. The pharmacist may then check the local device 50 to determine if authorization has been given, and, if appropriate, if payment for the pharmaceutical product has been made.

In accordance with a further illustrative embodiment of the present invention, the local device 50 may be located at an event site, and a child or other restricted party may transmit an authorization request to the parent's device 40 or the device 40 of the corresponding restricting party in order to obtain authorization to attend the particular event. The event cashier may then check the local device 50 to determine if authorization has been given, and, if appropriate, if payment for the event has been made.

In accordance with still another illustrative embodiment of the present invention, the local device 50 may be located at or built into a TV set, and a child or other restricted party may transmit an authorization request to the parent's device 40 or the device 40 of to corresponding restricting party in order to obtain authorization to watch a particular TV channel. In this case, if the parent or the corresponding restricting party gives authorization to watch the particular TV channel, the authorization request response to the local device 50 may include instructions for the local device 50 to automatically unlock the TV channel. If appropriate, the server 30 or the local device 50 may also charge a financial account of the restricting party for access to the TV channel.

In yet another illustrative embodiment of the present invention, the local device 50 may be located at or built into a computer, and a child or other restricted party may transmit an authorization request to the parent's device 40 or the device 40 of the corresponding restricting party in order to obtain authorization to access the Internet altogether or to obtain authorization to access certain restricted web sites. If appropriate, the server 30 or the local device 50 may also charge a financial account of the restricting party for access to the Internet or the restricted web sites.

In still another illustrative embodiment of the present invention, the local device 50 may be located at a school, and a child may transmit an authorization request to the parent's device 40 in order to obtain authorization to attend a class field trip. The teacher may then check the local device 50 to determine if authorization has been given, and, if appropriate, if payment for the class field trip has been made.

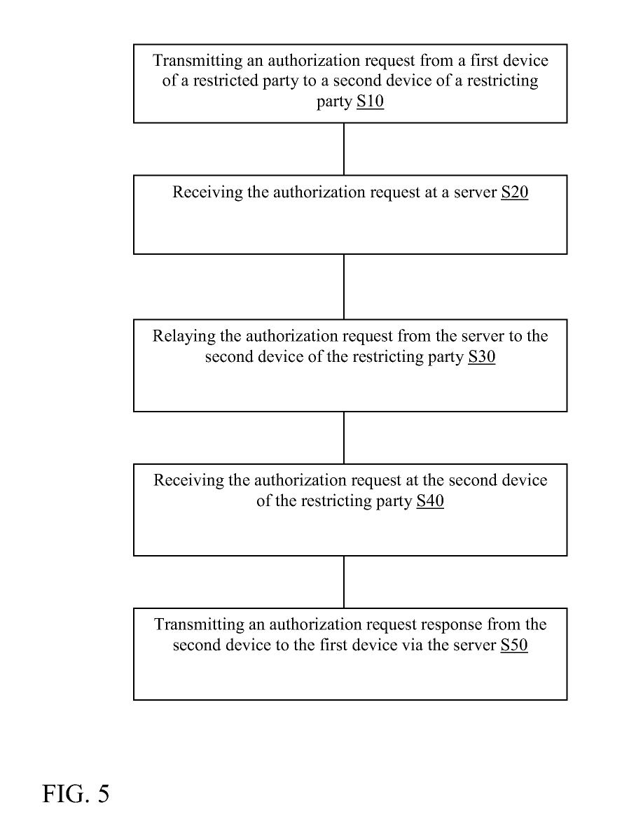

FIG. 5 depicts a flowchart of a method in accordance with an illustrative embodiment of the present invention. In step S10, an authorization request is transmitted from a first device of a restricted party to a second device of a restricting party. Therein, the authorization request requests access to restricted content and/or to a restricted event. In step S20, the authorization request is received at a server, and, in step S30, the authorization request is relayed from the server to the second device of the restricting party. In step S40, the authorization request is received at the second device of the restricting party, and, in step S50, an authorization request response is transmitted back from the second device to the first device via the server.

Referring again to FIG. 1, it is understood that server 30 may be implemented as any type of computing infrastructure. Server 30 generally includes a processor 32, memory 34, input/output (I/O) 38, and bus 18. The processor 32 may comprise a single processing unit, or be distributed across one or more processing units in one or more locations, e.g., on a client and server. Memory 34 may comprise any known type of data storage and/or transmission media, including magnetic media, optical media, random access memory (RAM), read-only memory (ROM), a data cache, a data object, etc. Moreover, memory 34 may reside at a single physical location, comprising one or more types of data storage, or be distributed across a plurality of physical systems in various forms.

I/O 38 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 18 provides a communication link between each of the components in the server 30 and likewise may comprise any known type of transmission link, including electrical, optical, wireless, etc. Although not shown, additional components, such as cache memory, communication systems, system software, etc., may be incorporated into the server 30.

Access to server 30 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, server 30 comprising an interactive access system 29 could be created, maintained and/or deployed by a service provider that offers the functions described herein for customers. That is, a service provider could offer to capture, compare, and notify regarding broadcast content as described above.

It is understood that in addition to being implemented as a system and method, the features may be provided as a program product stored on a computer-readable medium, which when executed, enables server 30 to provide an interactive access system 29. To this extent, the computer-readable medium may include program code, which implements the processes and systems described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 34 and/or a storage system, and/or as a data signal traveling over a network (e.g., during a wired/wireless electronic distribution of the program product).

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that terms such as “component” and “system” are synonymous as used herein and represent any combination of hardware and/or software capable of performing some function(s).

The block diagrams in the figures illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams can be implemented by special purpose hardware-based systems which perform the specified functions or acts, or combinations of special purpose hardware and computer instructions.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

The foregoing description of the preferred embodiments of this invention has been presented for purposes of illustration and description. It is not intended to be exhaustive or to limit the invention to the precise form disclosed, and clearly, many modifications and variations are possible.

What is claimed is:

1. A system for interactively obtaining access to at least one of restricted content and a restricted event, the system comprising:
a first device operable by a restricted party to transmit an access request to a restricting party, the access request requesting access to the at least one of the restricted content and the restricted event;
a server operable to receive the access request and to relay the access request to the restricting party; and
a second device operable by the restricting party to receive the access request from the server and to transmit an access request response to the first device via the server.

2. The system as claimed in claim 1, wherein at least one of the first device and the second device is selected from the group consisting of a Personal Digital Assistant (PDA), cellular phone, handheld computer, desktop computer, and laptop computer.

3. The system as claimed in claim 1, wherein the access request comprises a first Short Message Service (SMS) message, and wherein the access request response comprises a second SMS message.

4. The system as claimed in claim 1, wherein the access request response comprises data granting access to the at least one of the restricted content and the restricted event.

5. The system as claimed in claim 1, wherein the access request response comprises data denying access to the at least one of the restricted content and the restricted event.

6. The system as claimed in claim 1, further comprising a local device operable to receive the access request response from the second device via the server.

7. The system as claimed in claim 4, further comprising a financial institution server operable to charge a financial account of the restricting party upon granting access to the at least one of the restricted content and the restricted event.

8. The system as claimed in claim 6, wherein the local device is operable to receive the access request from the first device and to relay the access request to the server.

9. The system as claimed in claim 8, wherein the server is operable to receive a first identification number of the first device and a second identification number of the local device, and wherein the server is operable to match the first identification number and the second identification number with the second device pre-registered at the server in order to relay the authorization request from the first device to the second device.

10. A method for interactively obtaining access to at least one of restricted content and a restricted event, the method comprising:
transmitting an access request from a first device of a restricted party to a second device of a restricting party, the access request requesting access to the at least one of the restricted content and the restricted event;
receiving the access request at a server;
relaying the access request from the server to the second device of the restricting party;
receiving the access request at the second device of the restricting party; and
transmitting an access request response from the second device to the first device via the server.

11. The method as claimed in claim 10, wherein the access request response of the restricting party grants the restricted party access to the at least one of the restricted content and the restricted event.

12. The method as claimed in claim 10, wherein the access request response of the restricting party denies the restricted party access to the at least one of the restricted content and the restricted event.

13. The method as claimed in claim 10, wherein a local device receives the access request response from the second device via the server.

14. The method as claimed in claim 11, wherein a financial account of the restricting party is charged upon granting access to the at least one of the restricted content and the restricted event.

15. The method as claimed in claim 13, further comprising receiving the access request from the first device at the local device and relaying the access request from the local device to the server.

16. The method as claimed in claim 15, further comprising:
pre-registering the second device at the server;
receiving a first identification number of the first device and a second identification number of the local device at the server;
matching the first identification number and the second identification number with the pre-registered second device at the server; and
relaying the access request from the first device to the second device via the server.

17. A program product stored on a computer readable medium for interactively obtaining access to at least one of restricted content and a restricted event, the program product comprising:
program code for receiving an access request from a first device of a restricted party to a second device of a restricting party, the access request requesting access to the at least one of the restricted content and the restricted event;
program code for relaying the access request to the second device of the restricting party; and
program code for receiving an access request response from the second device to the first device.

18. The program product as claimed in claim 17, further comprising:
program code for pre-registering the second device;
program code for receiving a first identification number of the first device and a second identification number of the second device;
program code for matching the first identification number and the second identification number with the pre-registered second device at the server; and
program code for relaying the access request from the first device to the second device.

19. A method for deploying an application for interactively obtaining access to at least one of restricted content and a restricted event, comprising:
providing an infrastructure being operable to:
receive an access request from a first device of a restricted party to a second device of a restricting party, the access request requesting access to the at least one of the restricted content and the restricted event;
relay the access request to the second device of the restricting party; and
receive an access request response from the second device to the first device.

20. The method as claimed in claim 19, further comprising providing the infrastructure being operable to:
pre-register the second device;
receive a first identification number of the first device and a second identification number of the second device;
match the first identification number and the second identification number with the pre-registered second device at the server; and
relay the access request from the first device to the second device.
